(19) United States
(12) Patent Application Publication
(10) Pub. No.: US 2010/0218849 A1
(43) Pub. Date: Sep. 2, 2010

(54) Fuel tank opening-closing device

(75) Inventor: Hiroyuki Hagano, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/656,996

(22) Filed: Feb. 23, 2010

(30) Foreign Application Priority Data
Feb. 27, 2009 (JP) 2009-45315
Mar. 31, 2009 (JP) 2009-83940
Mar. 31, 2009 (JP) 2009-83941

(51) Int. Cl. B60K 15/05

(52) U.S. Cl. 141/350; 220/86.2

(57) ABSTRACT

A fuel tank opening-closing device includes a flap valve mechanism situated inside a tank opening forming member and having a flap valve mechanism; and an opening-closing activation mechanism adapted to selectively set the flap valve mechanism to a locked position or an unlocked position. The opening-closing activation mechanism includes a cover covering the peripheral edge portion of the opening-closing member and having a cover body produced by being split into arcuate shapes of prescribed width; a nozzle detection mechanism having introductory push parts that are adapted to receive force of motion in the insertion direction by a fueling nozzle; locking members which engage or disengage from the opening-closing member; and a locking mechanism having and adapted to move the locking members from the locked position to the unlocked position through interlocking operation with the introductory push parts.

This application claims the benefit of and priority from Japanese Applications No. 2009-45315 filed Feb. 27, 2009, No. 2009-83940 filed Mar. 31, 2009, and No. 2009-83941 filed Mar. 31, 2009, the contents of which are incorporated herein by reference.

### BACKGROUND OF THE INVENTION

1. Field of the Invention

The present invention relates to a fuel tank opening-closing device having a flapper valve adapted to open through insertion force of the fueling nozzle.

2. Description of the Related Art

Fueling nozzles for fueling an automobile are typically dimensioned differently to distinguish those dispensing gasoline from those dispensing gasoline diesel fuel, with a gasoline nozzle having a diameter of 20 mm while a diesel nozzle has a diameter of 25 mm. One known technology relating to such a fueling system with different nozzle diameters adapted to handle different types of fuel is disclosed in U.S. Pat. No. 6,968,874. Specifically, the fueling system includes a tank neck-defining member that defines a fueling port; a flapper valve pivotably supported at one edge thereof at the inside wall of the tank neck-defining member; and a latch mechanism capable of opening and closing the flapper valve when pushed by the fueling nozzle. The latch mechanism is positioned so that it will engage a diesel nozzle, but not a smaller gasoline nozzle. When a diesel nozzle is inserted, the nozzle will engage the latch mechanism causing the latch mechanism and the flapper valve to disengage; and upon further insertion of the fueling nozzle the flapper valve will open to a position permitting fueling.

In this prior art system, a small gap is formed between the filler port of the tank neck-defining member and the outside peripheral part of the flapper valve so as to prevent the flapper valve from colliding against the edge of the filler port, thereby ensuring smooth opening and closing operation. However, water and foreign matter may infiltrate from the outside through this gap at the rim of the filler port or become deposited therein, and the associated risk of diminished or degraded sealing function by the flapper valve proved to be a problem.

### SUMMARY

An advantage of some aspects of the invention is to provide a fuel tank opening-closing device of simple design adapted to prevent diminished or degraded sealing function by the flapper valve.

According to an aspect of the invention is provided with a fuel tank opening-closing device adapted to open and close a passage for supply of fuel to a fuel tank. The device comprises a tank opening forming member that forms a fuel passage connecting to the fuel tank from an insertion passage adapted for insertion of a fueling nozzle; a flap valve mechanism situated inside the tank opening forming member and having an opening-closing member adapted to open and close a filler port; and an opening-closing activation mechanism settable to a locked position in which opening operation of the opening-closing member is locked, and to an unlocked position in which opening operation of the opening-closing member is permitted when the opening-closing member is pushed by the fueling nozzle. The opening-closing activation mechanism includes: a cover having a cover bodies that is divided into arcuate shapes and is disposed covering a peripheral edge portion of the opening-closing member; a nozzle detection mechanism having an introductory push part disposed in the insertion passage and adapted to receive force of motion in an insertion direction of the fueling nozzle; and mating parts adapted to move the cover bodies in a direction away from the opening-closing member through force of motion of the introductory push part; and a locking mechanism having a locking member selectively shuttled to the locked position and the unlocked position, the locking member being configured to move from the locked position to the unlocked position through interlocking operation with the introductory push part.

With the fuel tank opening-closing device in accordance with the present invention, when a fueling nozzle is inserted through the insertion passage of the opening-defining member so that the tip of the fueling nozzle pushes against the introductory push parts of the nozzle detection mechanism, the cover body will travel in the direction away from the opening-closing member through the agency of the latch part; and the locking member of the locking mechanism will move from the locked position to the unlocked position to permit opening of the opening-closing member. As the fueling nozzle is pushed in further, the opening operation of the opening-closing member will take place so that fuel is supplied from the fueling nozzle to the fuel passage. When fueling has been completed and the fueling nozzle is withdrawn from the fuel passage and the insertion passage, the opening-closing member of the flap valve mechanism will be returned to its initial position by the spring force of the nozzle detection mechanism, and the cover will move in the direction of the center axis while the locking member engages the locked part. The opening-closing member will thereby be restored to its initial closed state.

Because the cover body of the cover covers the outside peripheral portion and the vicinity of the opening of the filler port from above, water resistance is afforded even during high-pressure washing, and additionally it will be harder for grime and the like to enter so that the sealing function of the flap valve mechanism will not be diminished or degraded. Moreover, the cover body of the cover, rather than being a plate member covering the entire face above the opening-closing member, instead covers only the top of the gap along the entire peripheral edge portion of the opening-closing member, so the design is simpler.

In another arrangement according to a second mode, the nozzle detection mechanism is furnished with shaft bodies adapted to rotatably support the introductory push parts on the tank opening forming member; and a linking arm linking the plurality of introductory push parts which have been disposed along the peripheral edge of the fuel passage, and adapted to produce spring force towards the direction of return to the original position through movement of the introductory push parts. Through this arrangement, an arrangement for returning the introductory push parts can be realized simply, without increasing the number of parts.

In yet another arrangement according to a third mode, the locking member has been integrally formed on the cover body.

In yet another arrangement according to a fourth mode, the nozzle detection mechanism is furnished with a fastened linking arm fastened to the tank opening forming member and linking the plurality of introductory push parts which have been disposed along the peripheral edge of the fuel passage; and resilient support pieces projecting in cantilever fashion from the fastened linking arm and adapted to produce spring force towards the direction of return to the original position through movement of the introductory push parts. Through this arrangement, an arrangement for returning the introductory push parts can be realized simply, without increasing the number of parts.

In yet another arrangement according to a fifth mode, the locking member of the locking mechanism has been integrally formed on the cover body.

In the opening-closing member of the flap valve mechanism there has been formed a frangible region having a notch formed between the locking part and a location sealed by a gasket, in the locked part which engages the locking member. When the locked part has been subjected to strong outside force exerted thereon by the introductory push parts through the locking member in response to outside force bearing on the tank opening forming member, the frangible region will break in a section thereof with the notch as the point of origin. Owing to the frangible region, only the locked part will break when subjected to such strong outside force through the locking member, and thus the gasket will be maintained in sealed condition by the opening-closing member. Because the frangible region consists of a notch that has been formed at the bottom of a recess in the locked part, in response to force exerted in a direction tending to expand the notch it will function as the point of origin of breakage so that the breaking load will be low; whereas in response to force received from the fueling nozzle by the push members of the opening-closing member, which is force in a direction tending to constrict the width of the notch, it will readily deform elastically so that the breaking load will be high. Consequently, the locked part will not break when the opening-closing member is subjected to force from the fueling nozzle, and the sealing function of the gasket will not be impaired.

In yet another arrangement according to a sixth mode, the locked part is a recess adapted to engage the locking member which has been formed in the side portion of the opening-closing member, and the notch has been formed at the bottom of the recess by reducing the thickness of the opening-closing member about the entire circumference of the opening-closing member. Such a notch can be easily designed so that the first breaking load will be greater than the second breaking load to readily achieve an arrangement for reducing mechanical strength in the locked part only.

In yet another arrangement according to a seventh mode, the opening-closing activation mechanism includes a cover having a cover body which has been formed by being split into arcuate shapes of prescribed width disposed covering the peripheral edge portion of the opening-closing member and positioned so as to move in a direction away from the opening-closing member in interlocking operation with the introductory push parts; the nozzle detection mechanism includes introductory push parts fastened in cantilever fashion at one end thereof to the tank opening forming member and adapted to produce spring force towards the direction of return to the original position through movement of the introductory push parts; and the locking member is formed at the opposite end of the introductory push part. Through this arrangement it is a simple matter to realize an arrangement whereby the locked part will be broken at the frangible region by the locking member.

In yet another arrangement according to an eighth mode, the opening-closing activation mechanism includes a cover having a cover body produced by splitting into arcuate shapes of prescribed width disposed covering the peripheral edge portion of the opening-closing member and positioned so as to move in a direction away from the opening-closing member in interlocking operation with the introductory push parts;

the nozzle detection mechanism includes shaft bodies adapted to rotatably support the introductory push parts on the tank opening forming member, and a linking arm linking the plurality of introductory push parts which have been disposed along the peripheral edge of the fuel passage and adapted to produce spring force towards the direction of return to the original position through movement of the introductory push parts; and the locking member has been integrally formed on the cover body. Through this arrangement it is a simple matter to realize an arrangement whereby the locked part will be broken at the frangible region by the locking member.

In yet another arrangement according to a ninth mode, the tank opening forming member and the introductory push parts are fabricated of conductive material having electrical conductivity, and constitute a grounding path to a chassis-side component of a vehicle. As the fueling nozzle is inserted into the insertion passage and bumps against the introductory push parts, the fueling nozzle becomes connected to the grounding path which leads to the chassis-side component through the introductory push parts and the tank opening forming member. Thus, even if static charge has built up in an individual holding the fueling nozzle, the charge can be quickly dispelled through the grounding path. Because the introductory push parts in contact with the fueling nozzle are utilized to provide a grounding path for the fuel tank opening-closing device, the need for a ground lead is obviated and the arrangement will be simpler; and because the fueling nozzle neutralizes electrical charge through contact against the introductory push parts prior contacting the opening-closing member, discharge towards the fuel tank from the opening-closing member will not occur. Moreover, even if the fueling nozzle is of small diameter such that it does not bump against the introductory push parts, because the opening operation of the opening-closing member does not take place, discharge towards the fuel tank from the opening-closing member will not occur.

In yet another arrangement according to a tenth mode, the nozzle detection mechanism has resilient support pieces fastening the introductory push parts at one end thereof in cantilever fashion to the tank opening forming member and adapted to produce spring force towards the direction of return to the original position through movement of the introductory push parts; the resilient support pieces have a conductive member fabricated of electrically conductive material and disposed facing the tank opening forming member; and the conductive member has discharge protrusions protruding out towards the tank opening forming member. Through this arrangement, when the resilient support piece has undergone elastic deformation, the discharge protrusions, with the resilient support piece as the fulcrum point, will likewise move closer to the opening-defining member, thus providing more dependable contact with the opening-defining member, as well as compensating for dimensional variations caused by deformation during molding or the like, so as to provide more dependable grounding action.

In yet another arrangement according to an eleventh mode, a plurality of introductory push parts are disposed surrounding the insertion passage; the nozzle detection mechanism further includes shaft bodies adapted to rotatably support the introductory push parts on the tank opening forming member, and a linking arm linking the plurality of introductory push parts and adapted to produce spring force towards the direction of return to the original position through movement of the introductory push parts; the tank opening forming member has a conductive member fabricated of electrically conductive material and disposed facing the linking arm; and the conductive member has discharge protrusions disposed facing the linking arm and projected out towards the linking arm.

In yet another arrangement according to a twelfth mode, a plurality of the introductory push parts are disposed surrounding the insertion passage and are fastened at one end thereof in cantilever fashion to the tank opening forming member and formed so as to produce spring force towards the direction of return to the original position through movement of the introductory push parts; the nozzle detection mechanism further includes a fastened linking arm fastened to the tank opening forming member and linking the plurality of introductory push parts; the tank opening forming member has a conductive member fabricated of electrically conductive material and disposed facing the fastened linking arm; and the electrically conductive member has discharge protrusions disposed facing the fastened linking arm and projected out towards the fastened linking arm.

The discharge protrusions will produce the same action regardless of whether they projects out from either the introductory push parts or the tank opening forming member towards the other, and may be selected appropriately depending on these arrangements. The discharge protrusions afford ease of setting the distance of the gap between the two, and can facilitate discharge along the path of electrical current flow through the air in the gap.

### BRIEF DESCRIPTION OF THE DRAWINGS

FIG. 1 is a perspective view depicting a rear section of an automobile equipped with a diesel engine according to a first embodiment of the present invention, shown with the fuel cover open;

FIG. 2 is a plan view depicting the opening of a fuel tank opening-closing device;

FIG. 3 is a sectional view taken along line 3-3 in FIG. 2;

FIG. 4 is a sectional view taken along line 4-4 in FIG. 2;

FIG. 5 is an enlarged sectional view of the flap valve mechanism and the opening-closing activation mechanism of FIG. 3;

FIG. 6 is an exploded perspective view of the opening-closing activation mechanism;

FIG. 7 shows the operation of a nozzle detection mechanism;

FIG. 8 shows the operation of a nozzle detection mechanism;

FIG. 9 shows the operation of a fuel tank opening-closing device;

FIG. 10 is an exploded perspective view showing a fuel tank opening-closing device according to a second embodiment;

FIG. 11 is a sectional view showing a fuel tank opening-closing device according to a third embodiment;

FIG. 12 is a plan view showing the opening of a fuel tank opening-closing device according to a fourth embodiment;

FIG. 13 is a sectional view taken along line 13-13 in FIG. 12;

FIG. 14 is a sectional view taken along line 14-14 in FIG. 12;

FIG. 15 is an enlarged sectional view of the flap valve mechanism and the opening-closing activation mechanism of FIG. 13;

FIG. 16 is an enlarged sectional view of the vicinity of the flap valve mechanism;

FIG. 17 is a side view of a push member;

FIG. 18 is an exploded perspective view of an opening-closing activation mechanism;

FIG. 19 shows a nozzle detection mechanism;

FIG. 20 shows the nozzle detection mechanism;

FIG. 21 shows the operation of a fuel tank opening-closing device;

FIG. 22 shows a breaking mechanism of an opening-closing activation mechanism;

FIG. 23 is an exploded perspective view of a fuel tank opening-closing device according to a fifth embodiment;

FIG. 24 is a sectional view of a fuel tank opening-closing device according to a sixth embodiment; and

FIG. 25 shows a nozzle detection mechanism of a fuel tank opening-closing device according to a seventh embodiment.

### DESCRIPTION OF THE PREFERRED EMBODIMENTS

### A. First Embodiment

(1) General Configuration of Fuel Tank Closure System

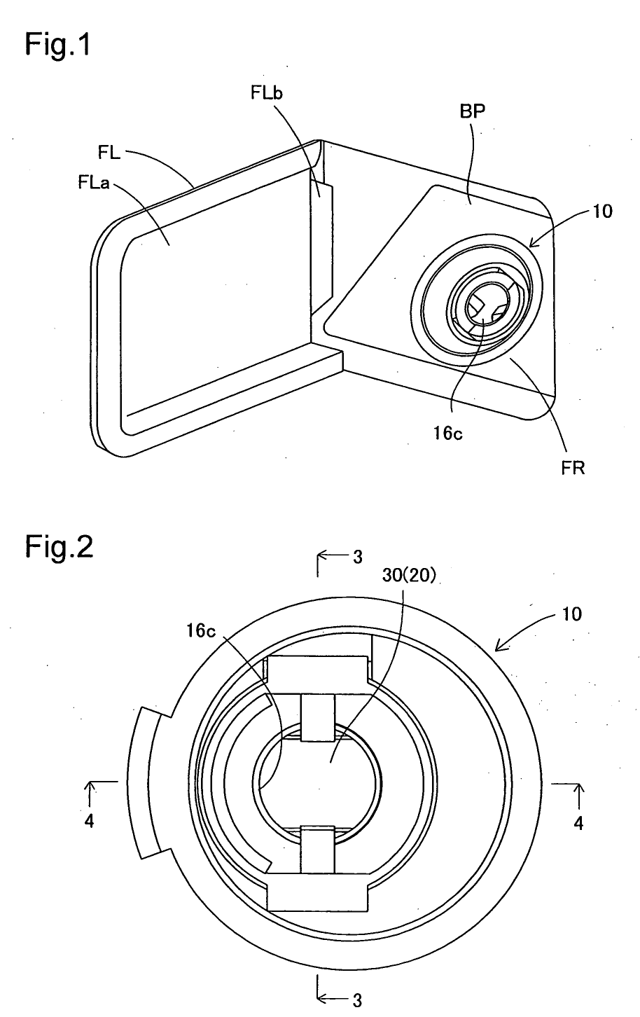

FIG. 1 is a perspective view depicting a rear section of an automobile equipped with a diesel engine according a first embodiment of the present invention, shown with the fuel cover open. A fuel cover FL for supplying a fuel (diesel) is reclosably supported at the rear section of the body of the automobile. The fuel cover FL has a cover body FLa conforming to the contours of the exterior panels of the vehicle and reclosably supported on a vehicle exterior panel via a hinge FLb. The space revealed by the opened fuel cover FL functions as a fueling bay FR, and a fuel tank opening-closing device 10 supported on a base plate BP has been arranged inside the fueling bay FR. The fuel tank opening-closing device 10 is a mechanism whereby fuel can be supplied from a fueling nozzle without using a fuel cap, and has been designed so that once the fuel cover FL has been opened, fuel can be supplied from a fueling nozzle to the fuel tank by opening or closing the fuel passage through outside force applied by the fueling nozzle. The specific design of the fuel tank opening-closing device will be discussed below.

(2) Design and Operation of the Parts

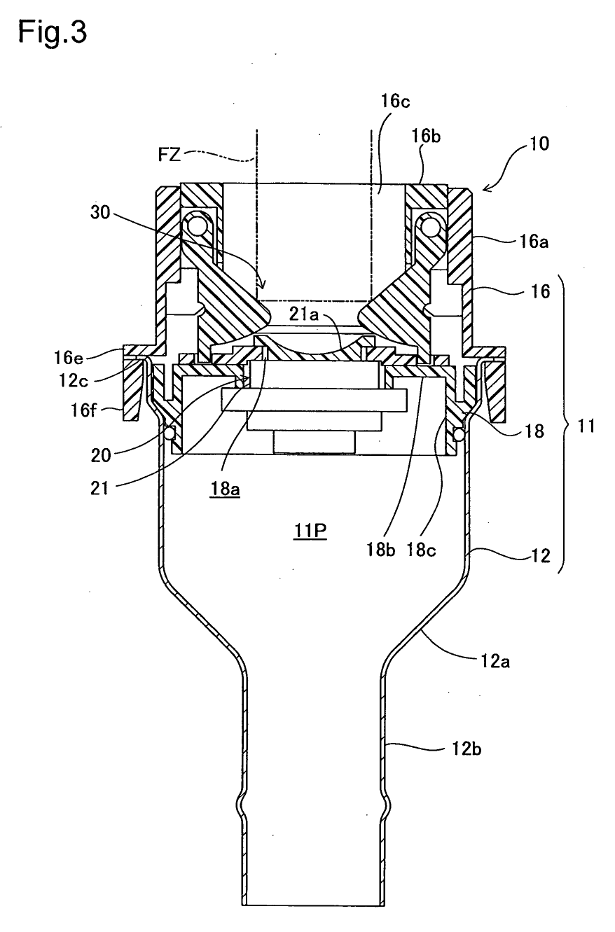

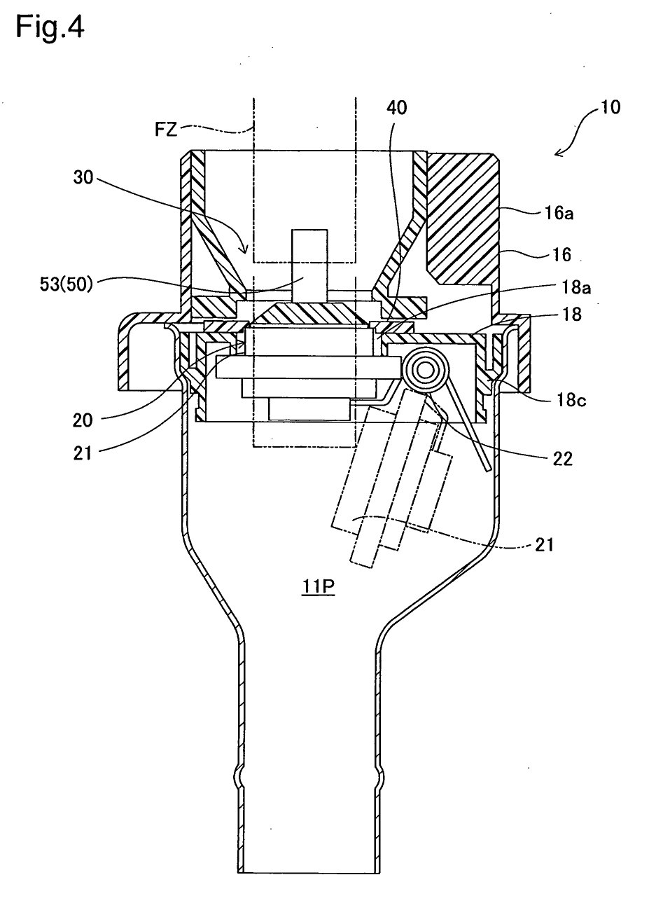

FIG. 2 is a plan view depicting the opening of the fuel tank opening-closing device 10; FIG. 3 is a sectional view taken along line 3-3 in FIG. 2; and FIG. 4 is a sectional view taken along line 4-4 in FIG. 2. In FIGS. 3 and 4, the fuel tank opening-closing device 10 includes a tank opening forming member 11 having a fuel passage 11P that connects to a fuel tank (omitted in the drawings); a flap valve mechanism 20; and an opening-closing activation mechanism 30 for opening and closing the flap valve mechanism 20 and for enhancing sealing function.

(2)-1 Tank Opening-Defining Member

In FIG. 3, the tank opening forming member 11 is a pipe that includes the fuel passage 11P; it also has a connecting pipe 12 that connects to the fuel tank, an opening-defining member 16 that has been secured to the upper part of the connecting pipe 12, and an filler port-defining member 18 that has been installed in the upper part of the connecting pipe 12.

The connecting pipe 12 includes a constricted diameter portion 12a of gradually constricted diameter towards the fuel tank end, and a straight pipe portion 12b connected to the constricted diameter portion 12a, these components having been integrally formed. The opening-defining member 16 is installed in the upper part of the connecting pipe 12, and includes a side wall 16a of round tubular shape, and an upper face portion 16b that has been integrally formed in the upper part of the side wall 16a. The lower part of the side wall 16a constitutes a lower tubular portion 16f extending from a somewhat flared expanded diameter portion 16e. An introductory port 16c has been formed in the center part of the upper face portion 16b.

The filler port-defining member 18 is a member that has been secured to the upper part of the connecting pipe 12, and functions to support part of the flap valve mechanism 20; it includes a circular plate part 18b having a filler port 18a that defines part of the fuel passage 11P, and a mating part 18c with a round tubular profile projecting from the outside peripheral portion of the circular plate part 18b and adapted to mate with the connecting pipe 12.

(2)-2 Flap Valve Mechanism 20

The flap valve mechanism 20 in FIG. 4 includes an opening-closing member 21, a spring 22, and a gasket, not shown. The opening-closing member 21 is a member that is axis-supported on the mating part 18c of the filler port-defining member 18, and is adapted to open or close the filler port 18a. The spring 22 is a helical torsion spring, one end of whose coil shape is supported on the filler port-defining member 18 and the other end of which is supported on the opening-closing member 21 so as to urge the opening-closing member 21 towards the closed direction. The gasket (not shown) is made of rubber material and has been arranged within the opening-closing member 21 to provide sealed closure between the opening-closing member 21 and the rim of the filler port 18a. The opening-closing member 21 has on its upper face a curving face 21a (see FIG. 3) which is curved in order to provide smooth contact with the fueling nozzle FZ. A regulator valve (omitted from the drawing) for regulating the pressure of the fuel tank is housed in the opening-closing member 21 of the flap valve mechanism 20.

(2)-3 Opening-Closing Activation Mechanism 30

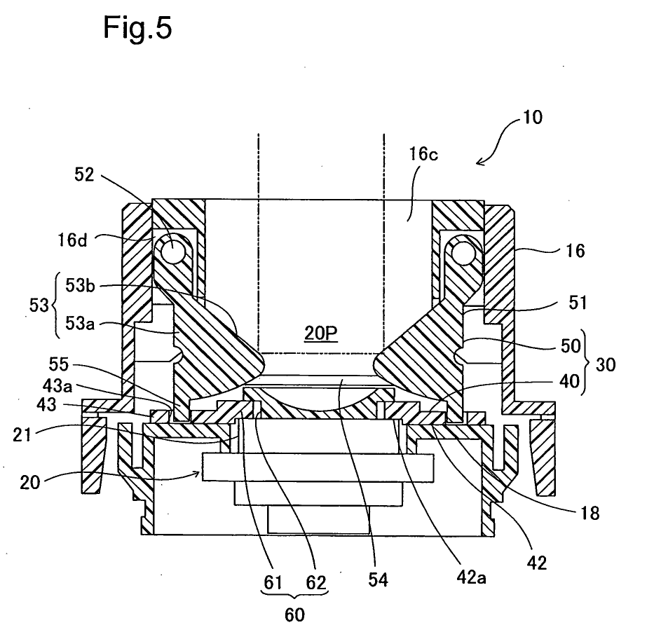

FIG. 5 is an enlarged sectional view of the flap valve mechanism 20 and the opening-closing activation mechanism 30 of FIG. 3. The opening-closing activation mechanism 30 is a mechanism disposed covering the rim of the opening-closing member 21 of the flap valve mechanism 20 from above, and is adapted to activate the opening operation when pushed by the tip of the fueling nozzle FZ; its principal elements are a cover 40, a nozzle detection mechanism 50, and a locking mechanism 60.

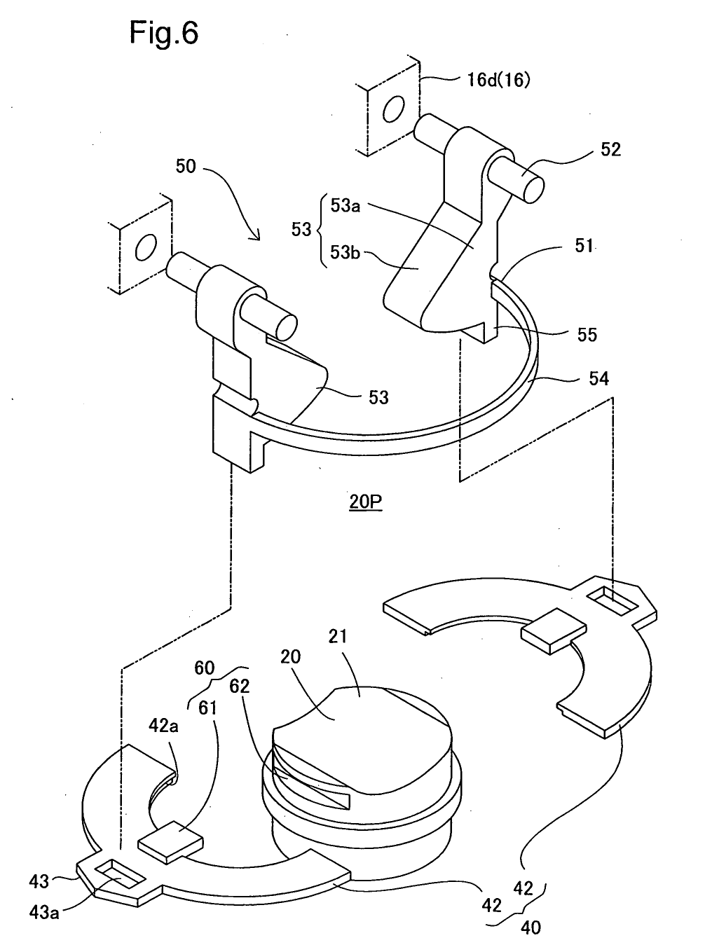

FIG. 6 is an exploded perspective view of the opening-closing activation mechanism 30. The cover 40 is a member that is disposed covering the rim of the opening-closing member 21 of the flap valve mechanism 20 from above, that is, it is arranged so as to cover the entire peripheral edge of the opening-closing member 21 of the flap valve mechanism 20, and includes a cover body 42 produced by being split into arcuate shapes of prescribed width. Each half of the cover body 42 encircles the opening-closing member 21 about half its circumference. A step 42a has been formed at the lower part of the inside peripheral edge of the cover body 42. As depicted in FIG. 5, the step 42a has been formed so as be positioned above the rim of the opening-closing member 21. A mated part 43 having a mating hole 43a has been formed in the outside peripheral part of each cover body 42.

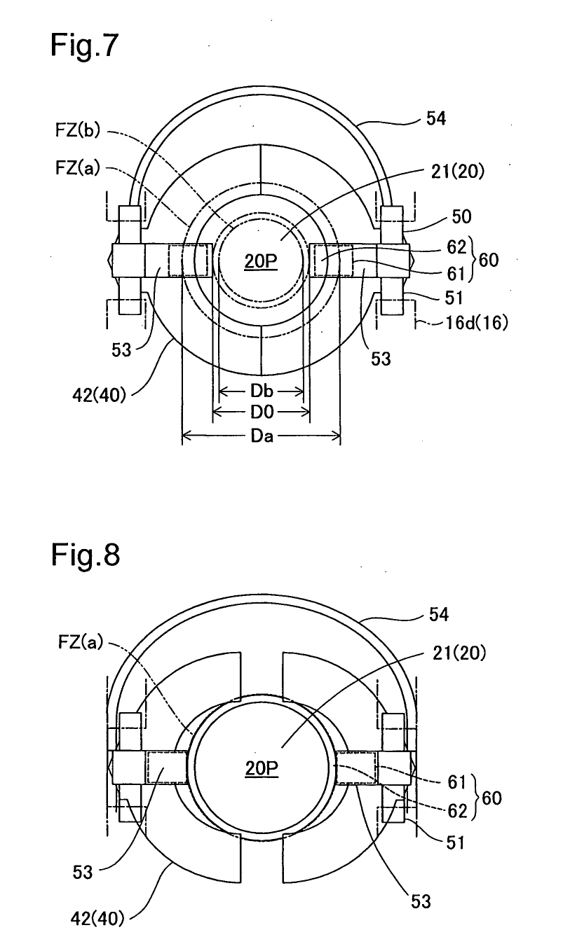

The nozzle detection mechanism 50 is a mechanism adapted to be pushed by the tip of a fueling nozzle having prescribed outside diameter, thereby releasing the opening-closing member 21 of the flap valve mechanism 20 from the locked state through the agency of the locking mechanism 60; it includes a nozzle detection member 51 that is supported by shaft support parts 16d provided to the opening-defining member 16. Specifically, the nozzle detection member 51 includes shaft bodies 52 that are axis-supported by the shaft support parts 16d of the opening-defining member 16; introductory push parts 53 disposed to either side of the insertion passage 20P and facing theretoward; a linking arm 54 of arched shape linking the introductory push parts 53; and mating parts 55 that protrude from the lower part of the introductory push parts 53, these elements being integrally formed. Each individual introductory push part 53 includes a push body 53a, and a sloping push face 53b which slopes downward and towards the insertion passage 20P side from the push body 53. The sloping push faces 53b have been positioned so that they will be pushed by the tip of the fueling nozzle FZ, provided that the tip of the fueling nozzle has an outside diameter of at least a prescribed diameter. FIGS. 7 and 8 are illustrations depicting the nozzle detection mechanism 50, with FIG. 7 showing the mechanism prior to insertion of the fueling nozzle, and FIG. 8 showing the mechanism with the fueling nozzle inserted. Specifically, where D0 denotes the inside diameter of the insertion passage 20P defined by the opposed inside edges of the introductory push parts 53, Da denotes the outside diameter of the tip of a diesel fueling nozzle (FZa), and Db denotes the outside diameter of a gasoline fueling nozzle (FZb), Db<D0<Da. For example, outside diameter Db may be set to 20 mm, inside diameter D0 to 22 mm, and outside diameter Da to 25 mm. The linking arm 54 is formed with semicircular ring shape, and acts as a spring by virtue of linking the introductory push parts 53, 53.

The locking mechanism 60 includes a locking member 61 that has been formed in the inside peripheral portion of the cover body 42, and a locked part 62 that has been formed on the opening-closing member 21. The locking member 61 is designed to engage with the locked part 62 and assume a locked position in which opening operation of the opening-closing member 21 is restricted; and to disengage from the locked part 62 by moving diametrically outward from the center direction of the opening-closing member 21 to assume an unlocked position in which opening operation of the opening-closing member 21 is permitted.

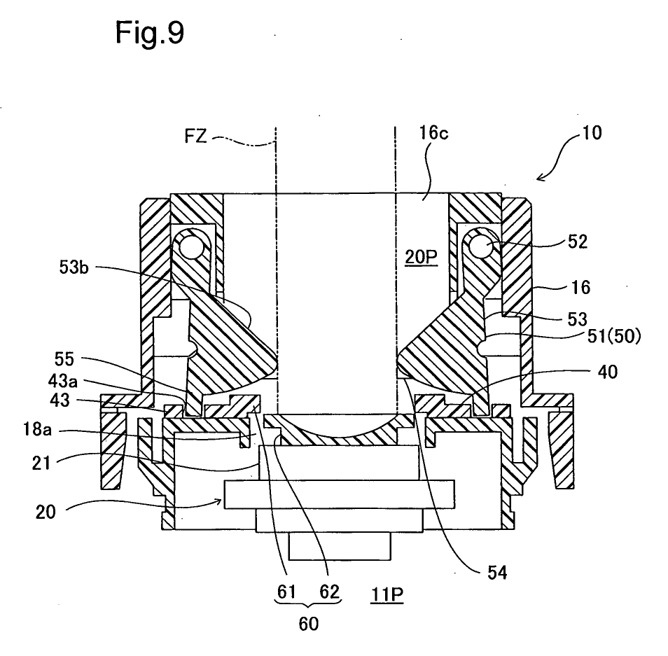

As shown in FIG. 6, through rotation in opposition to the spring force of the linking arm 54 taking place centered on the shaft bodies 52 which have been supported on the shaft support parts 16d provided to the opening-defining member 16, the nozzle detection member 51 will move the cover body 42 of the cover 40 towards the outside peripheral direction and shuttle the locking members 61 from the locked position to the unlocked position. FIG. 9 is an illustration depicting operation of the fuel tank opening-closing device 10. As shown in FIGS. 8 and 9, when the fueling nozzle (FZa) is inserted into the insertion passage 20P, it will push against the sloping push faces 53b of the introductory push parts 53 and unlock the opening-closing member 21 of the flap valve mechanism 20 so that the opening operation of the opening-closing member 21 is possible. Even where the inside diameter D0 of the insertion passage 20P is smaller than the outside diameter Db of the gasoline fueling nozzle (FZb), there will be a modicum of dimensional leeway, provided that the diameter is such that unlocking will not take place when the outside peripheral portion of the tip of the fueling nozzle (FZb) pushes against the sloping push faces 53b, so that fueling is not possible.

(3) Opening/Closing Operation of Fuel Tank Closure System

(3)-1 Opening Operation

As depicted in FIG. 1, opening the fuel cover FL reveals the fuel tank opening-closing device 10 which has been disposed in the fueling bay FR. When as shown in FIG. 5 the fueling nozzle FZ is inserted through the introductory port 16c of the opening-defining member 16, and the tip of the fueling nozzle FZ reaches the introductory push parts 53 of the nozzle detection mechanism 50 and pushes against the introductory push parts 53 so that the sloping push faces 53b are subjected to force exerted in the diametrical direction by the fueling nozzle FZ, the linking arm 54 (see FIG. 8) will undergo deflection as depicted in FIG. 9 so as to build up spring force, while the nozzle detection member 51 will undergo expansion centered on the center portion of the linking arm 54. As the nozzle detection member 51 expands, the mating parts 55 at the lower portion of the nozzle detection member 51 will induce movement of the cover 40 in the diametrically outward direction. The locking members 61 of the cover 40 will thereby disengage from the locked parts 62 and shuttle to the unlocked position. Opening operation of the opening-closing member 21 is made possible thereby.

As the fueling nozzle FZ is pushed further in, as depicted in FIG. 4 the opening-closing member 21 of the flap valve mechanism 20 will be pushed in opposition to the urging force of the spring 22, causing the opening-closing member 21 to rotate about its support axis so that the filler port 18a opens up. The fueling nozzle is then inserted into the filler port 18a whereupon fuel is supplied to the fuel passage 11P. In this way, pushing of the introductory push parts 53 of the nozzle detection member 51 by the fueling nozzle FZ will cause the locking members 61 of the cover 40 and the locked parts 62 of the opening-closing member 21 to become unlocked, and pushing against the opening-closing member 21 of the flap valve mechanism 20 will cause the opening-closing member 21 to open up the filler port 18a so that fueling can take place.

(3)-2 Closing Operation

Upon completion of fueling, when the fueling nozzle FZ is withdrawn from the filler port 18a, the opening-closing member 21 of the flap valve mechanism 20 will close up the filler port 18a owing to the restoring force of the spring 22. As the fueling nozzle FZ is withdrawn further, the nozzle detection member 51 and the cover 40 will return to their initial positions, namely, the introductory push parts 53 will return to their original positions through contraction of the linking arm 54 owing to elastic force, and the cover 40 will move back towards the center of the opening-closing member 21 so that the locking members 61 reengage with the locked parts 62. The opening-closing member 21 will thereby be restored to the initial state of being locked in the closed position, and the fuel cover FL (FIG. 1) will then be shut.

(4) Working Effects of the Fuel Tank Closure System

The fuel tank opening-closing device 10 according to the embodiment above affords the following working effects.

(4)-1 As depicted in FIG. 5, because the cover 40 covers the gap between the outside peripheral portion of the opening-closing member 21 and the opening perimeter of the filler port 18a from above, water resistance is afforded even during high-pressure washing; and additionally it will be harder for grime and the like to enter so that the sealing function of the flap valve mechanism 20 will not be diminished or degraded. Moreover, rather than being a plate member that covers the entire face above the opening-closing member 21, the cover 40 instead only covers the top of the gap along the entire peripheral edge portion of the opening-closing member 21, so its design is simpler.

(4)-2 The cover 40 need only move diametrically outward to a slight extent to permit opening operation of the opening-closing member 21, and thus a narrow space in the diametrical direction will suffice for a more compact arrangement; and since a high level of amplifying force by the nozzle detection mechanism 50 is not necessary, there is no need for a complex linking mechanism or the like.

(4)-3 Because the flap valve mechanism 20 is installed on the opening-defining member 16, as compared to a fuel cap of a type designed to be detached by unscrewing, there will be no difficulty in finding a place to put the detached cap during fueling, thus providing greater ease of operation.

(4)-4 As depicted in FIGS. 7 and 8, the nozzle detection mechanism 50 is furnished with introductory push parts 53 that have been positioned so as to be pushed by the tip of the fueling nozzle FZ if the outside diameter of the nozzle is greater than a prescribed diameter, so opening operation of the opening-closing member 21 of the flap valve mechanism 20 will take place in the case of a diesel fueling nozzle (FZa), whereas opening operation of the opening-closing member 21 will not take place in the case of a gasoline fueling nozzle (FZb). Consequently, in instances where the type of fuel differs according to the outside diameter of the fueling nozzle FZ, the filler port 18a will not open if the wrong fueling nozzle FZ is inserted, thus making it impossible to supply the wrong fuel.

(4)-5 Because the opening-closing activation mechanism 30 has been designed to open the opening-closing member 21 when the introductory push parts 53 of the nozzle detection mechanism 50 are pushed by the fueling nozzle FZ, there is no need to provide an actuating mechanism such as a switch or motor for controlling opening and closing, thus affording a simpler design.

(4)-6 Because the introductory push parts 53 of the nozzle detection member 51 are linked in such a way as to move the cover 40 which is a separate component, these two different components can be fabricated of resin appropriate to their respective functions. For example, polyacetal, which is a material having low frictional resistance, could be used for the introductory push parts 53, while glass-filled polyamide, which is a material with high mechanical strength, could be used for the cover 40, to obtain a fuel tank opening-closing device 10 of exceptional durability.

### B. Second Embodiment

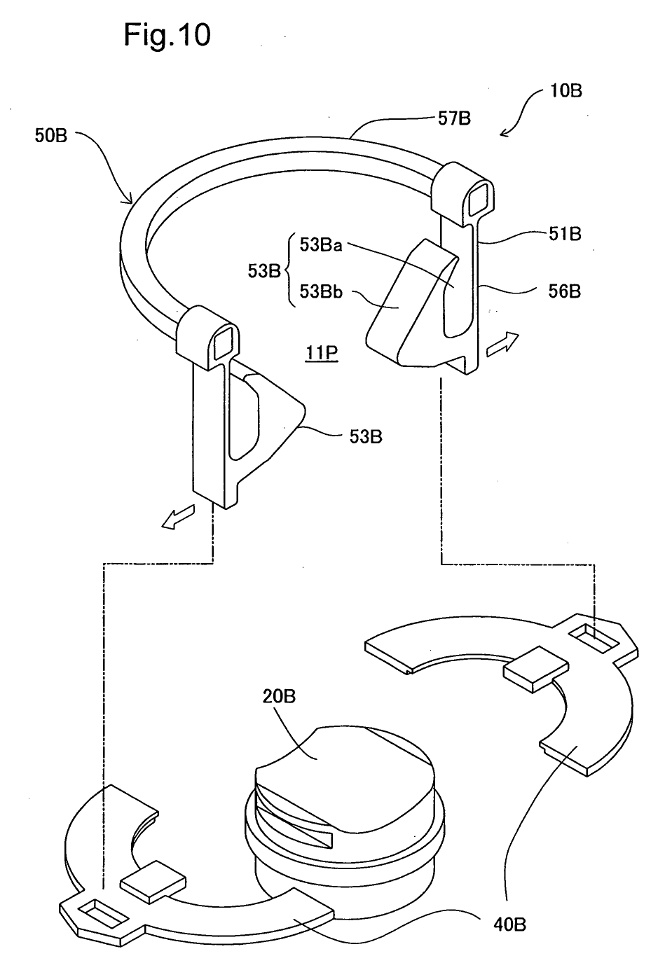

FIG. 10 is an exploded perspective view showing a fuel tank opening-closing device 10B according to a second embodiment. A feature of the present embodiment is the arrangement of a nozzle detection mechanism 50B for detecting insertion of a fueling nozzle. Specifically, a nozzle detection member 51B of this nozzle detection mechanism 50B includes introductory push parts 53B disposed to both sides of the fuel passage 11P; resilient support pieces 56B linked at one end thereof to the introductory push parts 53B so as to extend upward therefrom; and a fastened linking arm 57B that links the resilient support pieces 56B in their upper portion. The fastened linking arm 57B is a band-shaped member of semicircular form fastened to the opening-defining member. With this arrangement, when the introductory push parts 53B, 53B are pushed towards the perpendicular direction with respect to the direction of insertion of the fueling nozzle FZ, spring force is generated centered on the upper part of the resilient support pieces 56B, causing the covers 40B to move in the retracting direction and to then subsequently return to their initial positions when the fueling nozzle has been withdrawn. Besides an integrated spring as described above, various other modes, such as a separate coil spring or plate spring, could be employed as the arrangement whereby the nozzle detection mechanism generates spring force through traveling force of the introductory push parts.

### C. Third Embodiment

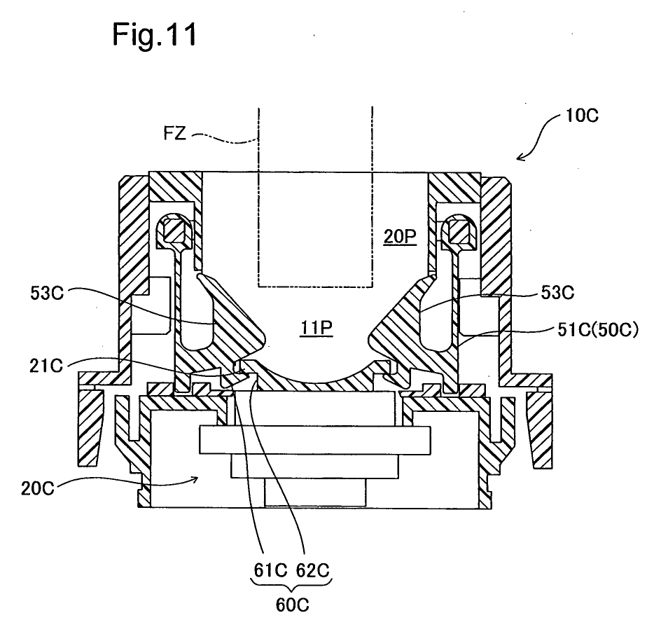

FIG. 11 is a sectional view showing a fuel tank opening-closing device 10C according to a third embodiment. A feature of the present embodiment is the arrangement of a locking mechanism 60C adapted to operate in interlocked fashion in association with insertion of the fueling nozzle FZ. Specifically, locking members 61C of the locking mechanism 60 have been integrally formed with introductory push parts 53C and are designed to shuttle between a locked position at which the locking members 61C are engaged by locked parts 62C of an opening-closing member 21C, and an unlocked position at which through pushing of the introductory push parts 53C the locking members 61C have disengaged from the locked parts 62C so that the opening operation of the opening-closing member 21C becomes possible. Thus, an arrangement whereby the locking members 61C of the locking mechanism 60 shuttle between the locked position and the unlocked position with respect to the opening-closing member 21C through interlocking operation with the introductory push parts 53C is also acceptable.

### D. Fourth Embodiment

(1) General Configuration

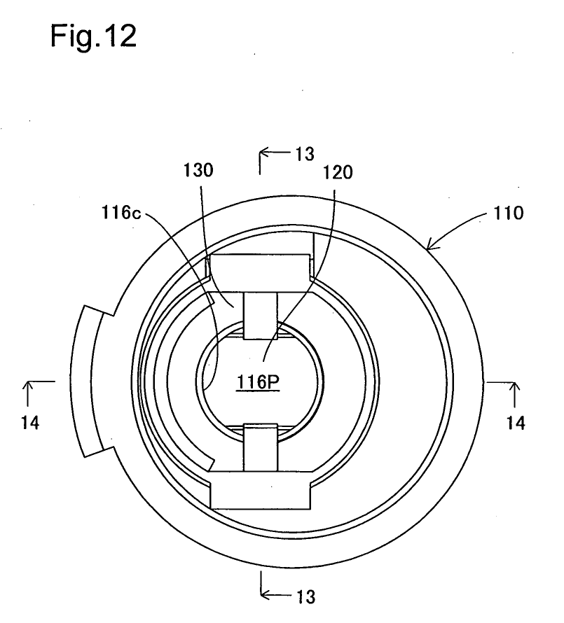

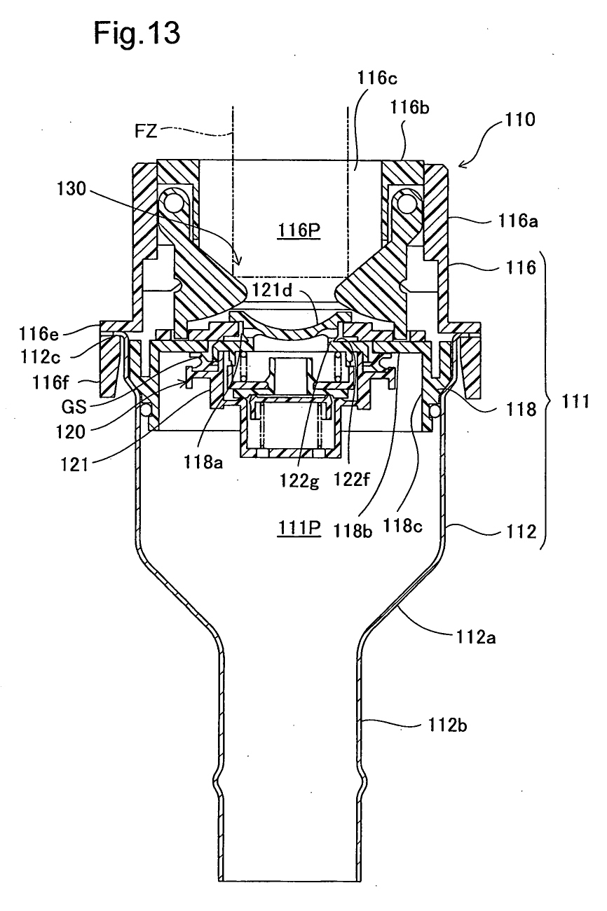

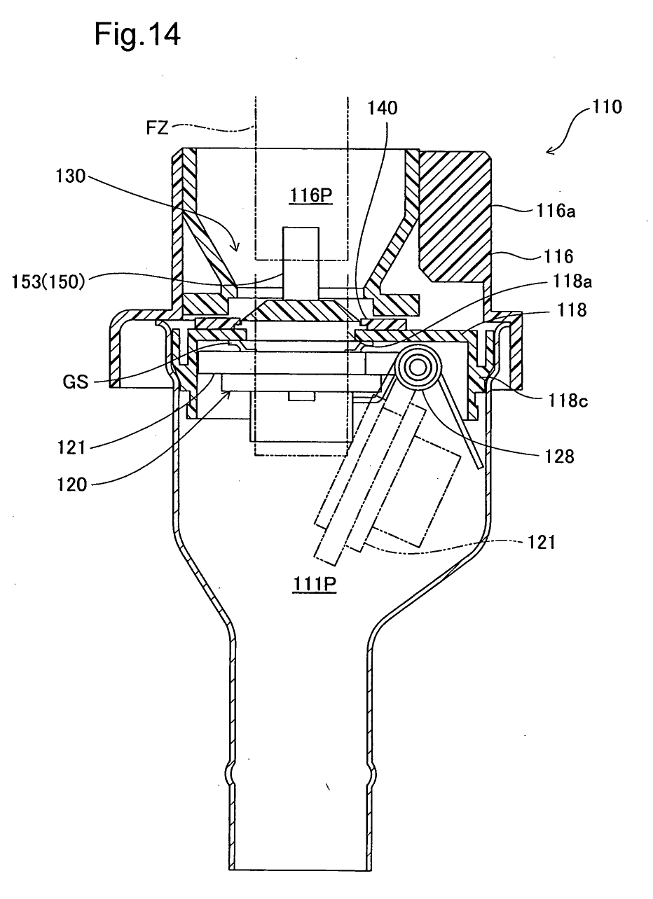

FIG. 12 is a plan view showing the opening part of a fuel tank opening-closing device 110 according to a fourth embodiment; FIG. 13 is a sectional view taken along line 13-13 in FIG. 12; and FIG. 14 is a sectional view taken along line 14-14 in FIG. 12. In FIGS. 13 and 14, the fuel tank opening-closing device 110 includes a tank opening forming member 111 having a fuel passage 111P that connects to a fuel tank (not shown); a flap valve mechanism 120; and an opening-closing activation mechanism 130 for opening and closing the flap valve mechanism 120 and for enhanced sealing function.

(2) Configuration of Parts

(2)-1 Configuration of Flap Valve Mechanism 120

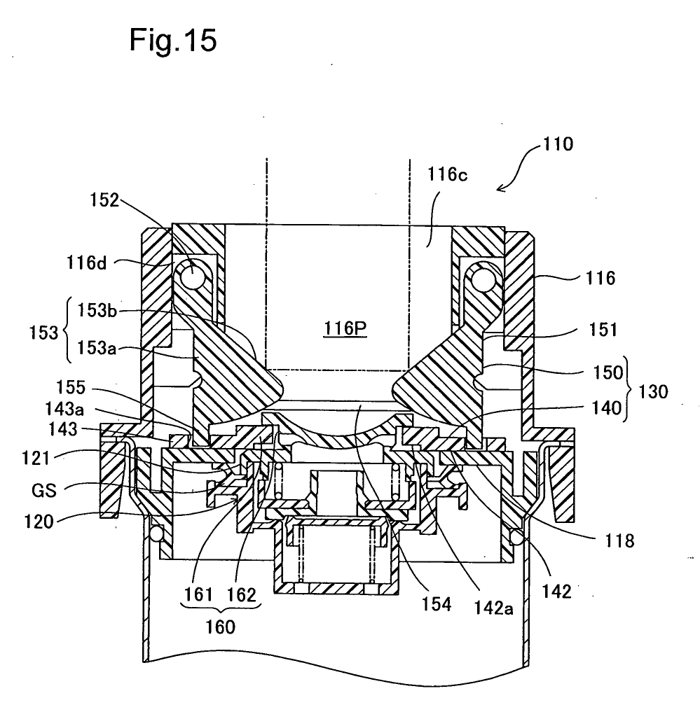

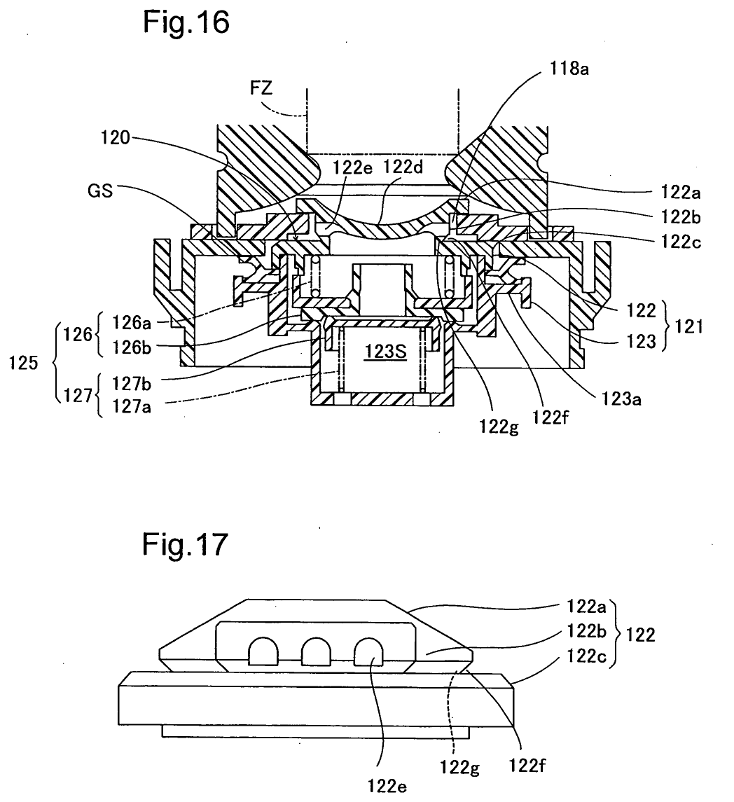

FIG. 15 is an enlarged sectional view of the flap valve mechanism 120 and the opening-closing activation mechanism 130 of FIG. 13; and FIG. 16 is an enlarged sectional view of the vicinity of the flap valve mechanism 120. In FIG. 16, the mechanism includes an opening-closing member 121; a push member 122; a valve chamber defining member 123; a regulator valve 125; and a gasket GS. The push member 122 is a bottomed, substantially tubular member adapted to directly receive pushing force from the fueling nozzle FZ; it is formed by an upper face part 122a, a side wall 122b that has been projected from the outside periphery of the upper face part 122a, and a flange 122c. A curving face 122d that is curved in order to provide smooth contact with the fueling nozzle FZ has been formed on the upper face part 122a. FIG. 17 is a side view of the push member 122. Vent holes 122e have been formed respectively at three locations in the side wall 122b of the push member 122. Between the side wall 122b and the flange 122c of the push member 122, a notch 122f has been formed around the entire outside circumferential portion. The notch 122f constitutes a frangible region 122g with reduced mechanical strength by virtue of having smaller thickness in the plate thickness direction of the push member 122 about the entire circumference. The gasket GS is made from rubber material, and is retained on the opening-closing member 121 by virtue of being clasped between the flange 122c of the push member 122 and a flange 123a provided to the valve chamber defining member 123, and is adapted to provide sealed closure with the rim of the filler port 118a. The regulator valve 125 is framed by the push member 122 and the valve chamber defining member 123 and is accommodated within a valve chamber 123S that has been connected to the vent holes 122e; it includes a positive pressure valve 126 having a positive pressure valve body 126b that is urged by a spring 126a, and a negative pressure valve 127 having a negative pressure valve body 127b that is urged by a spring 127a, and is adapted to regulate pressure of the fuel tank through opening and closing of the two valve bodies so that tank internal pressure of the fuel tank stays within a prescribed range.

(2)-2 Opening-Closing Activation Mechanism 30

In FIG. 15, the opening-closing activation mechanism 130 is a mechanism adapted to cover the rim of the opening-closing member 121 of the flap valve mechanism 120 from above, and to carry out opening operation when pushed by the tip of the fueling nozzle FZ; its principal elements include a cover 140, a nozzle detection mechanism 150, and a locking mechanism 160.

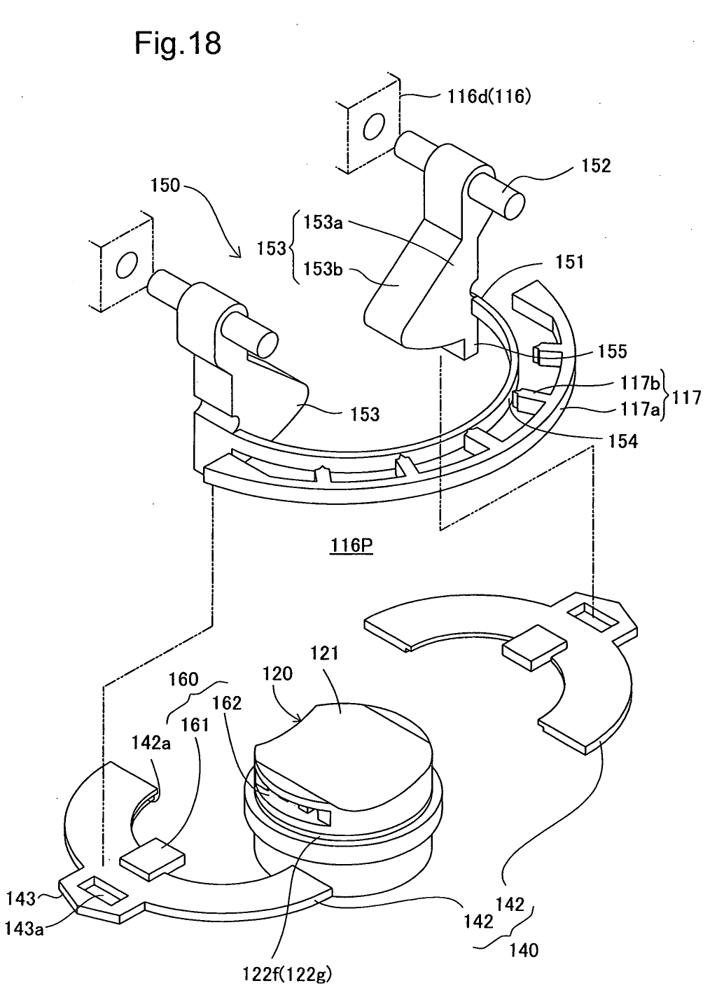

FIG. 18 is an exploded perspective view of the opening-closing activation mechanism 130. The cover 140 is a member disposed covering the rim of the opening-closing member 121 of the flap valve mechanism 120 from above, that is, it is arranged so as to cover the entire peripheral edge of the opening-closing member 21 of the flap valve mechanism 20, and includes a cover body 142 produced by being split into arcuate shapes of prescribed width. Each half of the cover body 142 encircles the opening-closing member 121 about half its circumference. A step 142a has been formed at the lower part of the inside peripheral edge of the cover body 142. As depicted in FIG. 15, the step 142a has been formed so as be positioned above the rim of the opening-closing member 121. A mated part 143 having a mating hole 143a has been formed in the outside peripheral part of each cover body 142.

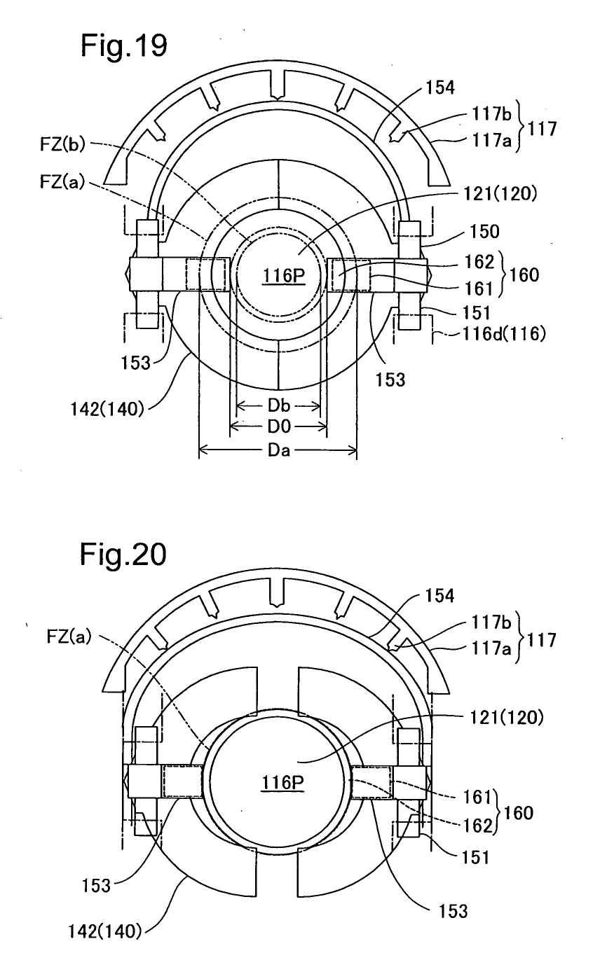

In FIG. 18, the nozzle detection mechanism 150 is a mechanism adapted to be pushed by the tip of a fueling nozzle having prescribed outside diameter, thereby releasing the opening-closing member 121 of the flap valve mechanism 120 from the locked position through the agency of the locking mechanism 160; it includes a nozzle detection member 151 that is supported by shaft support parts 116d provided to the opening-defining member 116. The nozzle detection member 151 includes shaft bodies 152 that are axis-supported by the shaft support parts 116d of the opening-defining member 116; introductory push parts 153 disposed to either side of an insertion passage 116P and facing theretoward; a linking arm 154 that links the introductory push parts 153; and mating parts 155 that protrude from the lower part of the introductory push parts 153, these elements being integrally formed. Each individual introductory push part 153 includes a push body 153a, and a sloping push face 153b which slopes downward and towards the insertion passage 116P side from the push body 153. The sloping push faces 153b have been positioned so that they will be pushed by the tip of the fueling nozzle FZ, provided that the tip of the fueling nozzle has an outside diameter of at least a prescribed diameter. FIGS. 19 and 20 are illustrations depicting the nozzle detection mechanism 150, with FIG. 19 showing the mechanism prior to insertion of the fueling nozzle, and FIG. 20 showing the mechanism with the fueling nozzle inserted. Specifically, where D0 denotes the inside diameter of the insertion passage 116P defined by the opposed inside edges of the introductory push parts 153, 153, Da denotes the outside diameter of the tip of the diesel fueling nozzle (FZa), and Db denotes the outside diameter of the gasoline fueling nozzle (FZb), Db<D0<Da. For example, outside diameter Db may be set to 20 mm, inside diameter D0 to 22 mm, and outside diameter Da to 25 mm. The linking arm 154 is formed with semicircular ring shape, and acts as a spring by virtue of linking the introductory push parts 153, 153.

In FIG. 18, the locking mechanism 160 includes a locking member 161 that has been formed in the inside peripheral portion of the cover body 142, and a locked part 162 that has been formed as a recess in the opening-closing member 121. The locking member 161 is designed to engage the locked part 162 and assume a locked position in which opening operation of the opening-closing member 121 is restricted; and to disengage from the locked part 162 by moving diametrically outward from the center direction of the opening-closing member 121 to assume an unlocked position in which opening operation of the opening-closing member 121 is permitted.

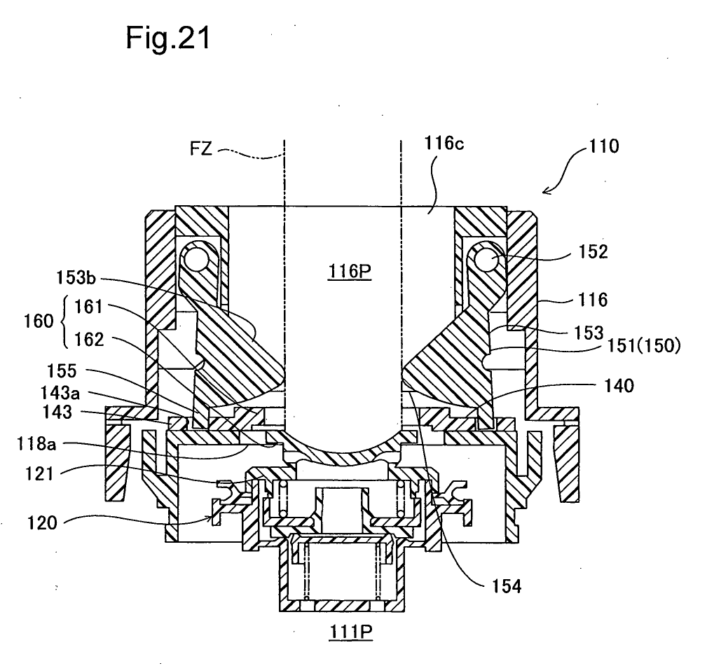

Through rotation in opposition to the spring force of the linking arm 154 taking place centered on the shaft bodies 152 which have been supported on the shaft support parts 116d provided to the opening-defining member 116, the nozzle detection member 151 will move the cover body 142 of the cover 140 towards the outside peripheral direction and shuttle the locking members 161 from the locked position to the unlocked position. FIG. 21 is an illustration depicting operation of the fuel tank opening-closing device 110. As shown in FIGS. 19, 20, and 21, when the fueling nozzle FZa is inserted into the insertion passage 116P, it will push against the sloping push faces 153b of the introductory push parts 153 and unlock the opening-closing member 121 of the flap valve mechanism 120 so that the opening operation of the opening-closing member 121 is possible. Even where the inside diameter D0 of the insertion passage 116P is smaller than the outside diameter Db of the gasoline fueling nozzle (FZb), there will be a modicum of dimensional leeway, provided that the diameter is such that unlocking will not take place when the outside peripheral portion of the tip of the fueling nozzle (FZb) pushes against the sloping push faces 153b, so that fueling is not possible.

In FIG. 18, the opening-defining member 116 and the nozzle detection member 151 are fabricated of conductive material thereby constituting a grounding path that is connected to a component on the vehicle chassis side through a metal connecting pipe 112 (FIG. 13). Specifically, a conductive member 117 constituting part of the opening-defining member 116 has been positioned to the outside peripheral side of the linking arm 154 of the nozzle detection member 151. The conductive member 117 is made of a conductive material and includes an annular basal part 117a which is a semi-circular arm, and a plurality of discharge protrusions 117b which have been arranged at prescribed angles in the circumferential direction along the inside peripheral portion of the basal part 117a. The conductive member 117 may also be integrally formed with the inside wall of the opening-defining member 116. The discharge protrusions 117b are positioned at gaps of 0.5 mm or smaller from the linking arm 154 with the linking arm 154 in a deflected condition (the condition shown in FIG. 20), so that discharge through insulation breakdown in the air is possible. The conductive material used to form the tank opening forming member 111 and the introductory push parts 153 may be obtained by admixing one or several materials selected from conductive whiskers, conductive carbon, or conductive graphite powder into a resin material, for example, by admixing 5 weight parts of conductive whiskers and 10 weight parts of conductive carbon into 100 weight parts of polyacetal or polyamide (PA). Here, DENTALL (trade name of Otsuka Chemical Co. Ltd.) can be used as the conductive whiskers, and VULCAN XC-72 (trade name of Cabot Corp.) can be used as the conductive carbon. Besides polyacetal and polyamide, the resin for imparting conductivity can be any material with good fuel resistance and imperviousness to fuel, such as fluororesins (ETFE) for example.

(3) Opening/Closing Operation of Fuel Tank Closure System

(3)-1 Opening Operation

Opening the fuel cover FL reveals the fuel tank opening-closing device 110 which has been disposed in the fueling bay FR. When as shown in FIG. 15 the fueling nozzle FZ is inserted through the introductory port 116c of the opening-defining member 116, and the tip of the fueling nozzle FZ reaches the introductory push parts 153 of the nozzle detection mechanism 150 and pushes against the introductory push parts 153 so that the sloping push faces 153b are subjected to force exerted in the diametrical direction by the fueling nozzle FZ, the linking arm 154 (see FIG. 18) will undergo deflection as depicted in FIG. 19 so as to build up spring force, while the nozzle detection member 151 will undergo expansion centered on the center portion of the linking arm 154. As the nozzle detection member 151 expands, the mating parts 155 at the lower portion of the nozzle detection member 151 will induce movement of the cover 140 in the diametrically outward direction. The locking members 161 of the cover 140 will thereby disengage from the locked parts 162 and shuttle to the unlocked position. Opening operation of the opening-closing member 121 will be possible thereby.

As the fueling nozzle FZ is pushed further in, as depicted in FIG. 14 the opening-closing member 121 of the flap valve mechanism 120 will be pushed in opposition to the urging force of the spring 128, causing the opening-closing member 121 to rotate about its support axis so that the filler port 118a opens up. The fueling nozzle is then inserted into the filler port 118a whereupon fuel is supplied to the fuel passage 111P. In this way, pushing of the introductory push parts 153 of the nozzle detection member 151 by the fueling nozzle FZ will cause the locking members 161 of the cover 140 and the locked parts 162 of the opening-closing member 121 to become unlocked, and pushing against the opening-closing member 121 of the flap valve mechanism 120 will cause the opening-closing member 121 to open up the filler port 118a so that fueling can take place.

(3)-2 Closing Operation

Upon completion of fueling, when the fueling nozzle FZ is withdrawn from the filler port 118a, the opening-closing member 121 of the flap valve mechanism 120 will close up the filler port 118a owing to the restoring force of the spring 128; and as the fueling nozzle FZ is withdrawn further, the nozzle detection member 151 and the cover 140 will return to their initial positions, namely, the introductory push parts 153 will return to their original positions through contraction of the linking arm 154 owing to elastic force, and the cover 140 will move back towards the center of the opening-closing member 121 so that the locking members 161 reengage with the locked parts 162. The opening-closing member 121 will thereby be restored to the initial state of being locked in the closed position, and the fuel cover FL will then be shut.

(4) Working Effects of the Fuel Tank Closure System

The fuel tank opening-closing device 110 according to the embodiment above affords the following working effects.

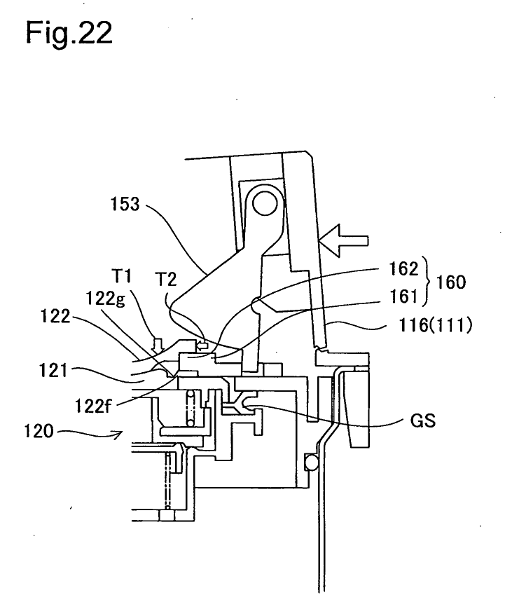

(4)-1 As depicted in FIG. 22, a frangible region 122g formed by a notch 122f in proximity to the locked part 162 which engages the locking member 161 has been formed in the opening-closing member 121 of the flap valve mechanism 120. When the locked part 162 has been subjected to strong outside force T2 through the locking member 161 from the introductory push part 153 due to outside force having been applied to the opening-defining member 116 of the tank opening forming member 111, the frangible region 122g will break in a section that has the notch as the point of origin. Because the frangible region 122g has been provided in a recess of the locked part 162 so that only an area in proximity to the locked part 162 will break when subjected to strong outside force T2 exerted through the locking member 161, the sealing function of the gasket GS by the opening-closing member 121 will be maintained. Also, because the frangible region 122g consists of the notch 122f which has been formed at the bottom of a recess in the locked part 162, in response to the force T2 exerted in a direction tending to expand the notch 122f it will function as the point of origin of breakage so that the breaking load will be low; whereas in response to force T1 received from the fueling nozzle by the push members 122 of the opening-closing member 121, which is force in a direction tending to constrict the width of the notch 122f, it will readily deform elastically so that the breaking load will be high. Consequently, the locked part 162 will not break when the opening-closing member 121 is subjected to force from the fueling nozzle FZ, and the sealing function of the gasket GS will not be impaired. Moreover, there will be no need for measures typically employed in the prior art in order to maintain sealing with respect to outside force such as a collision, namely, an arrangement for securely joining the opening-defining member 116 and the connecting pipe 112 (FIG. 13) or a protector in order to protect the opening-defining member 116, so the number of parts can be reduced.

(4)-2 The locked part 162 is a recess designed to be engaged by the locking member 161 which has been formed on the side of the opening-closing member 121, and the notch 122f has been produced in the bottom of this recess by reducing the thickness of the opening-closing member 121. That is, this sort of arrangement for the notch 122f can be easily be realized by reducing the thickness of the opening-closing member 121 about the entire circumference to reduce the mechanical strength of the locked part 162 only.

(4)-3 As depicted in FIG. 18, the opening-defining member 116 and the introductory push parts 153 have been fabricated of conductive material, and the opening-defining member 116 has been attached to the metal connecting pipe 112 (FIG. 13), thereby creating a grounding path to a chassis-side component of the vehicle. When the fueling nozzle FZ is inserted into the insertion passage 116P and comes into contact with the introductory push parts 153, the fueling nozzle FZ becomes connected to the grounding path to the chassis-side component via the introductory push parts 153 and the tank opening forming member 111. Thus, even if static charge has built up in the individual who is holding the fueling nozzle FZ, the charge can be quickly dispelled through the grounding path. Because this grounding path for the fuel tank opening-closing device is assured by utilizing contact of the fueling nozzle FZ against the introductory push parts 153, the need for a ground lead is obviated so the arrangement is simpler; and because the fueling nozzle FZ neutralizes electrical charge through contact against the introductory push parts 153 prior contacting the opening-closing member 121, discharge towards the fuel tank from the opening-closing member 121 will not occur. Moreover, even if the fueling nozzle FZ is of small diameter such that it does not bump against the introductory push parts 153, because the opening operation of the opening-closing member 121 does not take place, discharge towards the fuel tank from the opening-closing member 121 will not occur.

(4)-4 Because a plurality of the discharge protrusions 117b have been situated at prescribed spacing in the circumferential within a 180° range of the linking arm 154, a grounding path can be dependably assured at one location, even if shape or dimensional irregularities, such as deformation of the semicircle of the linking arm 154, should occur.

(4)-5 Because the discharge protrusions 117b are protrusions that taper to a point at the distal end, discharge can take place readily over a path of current flow through the air.

### E. Fifth Embodiment

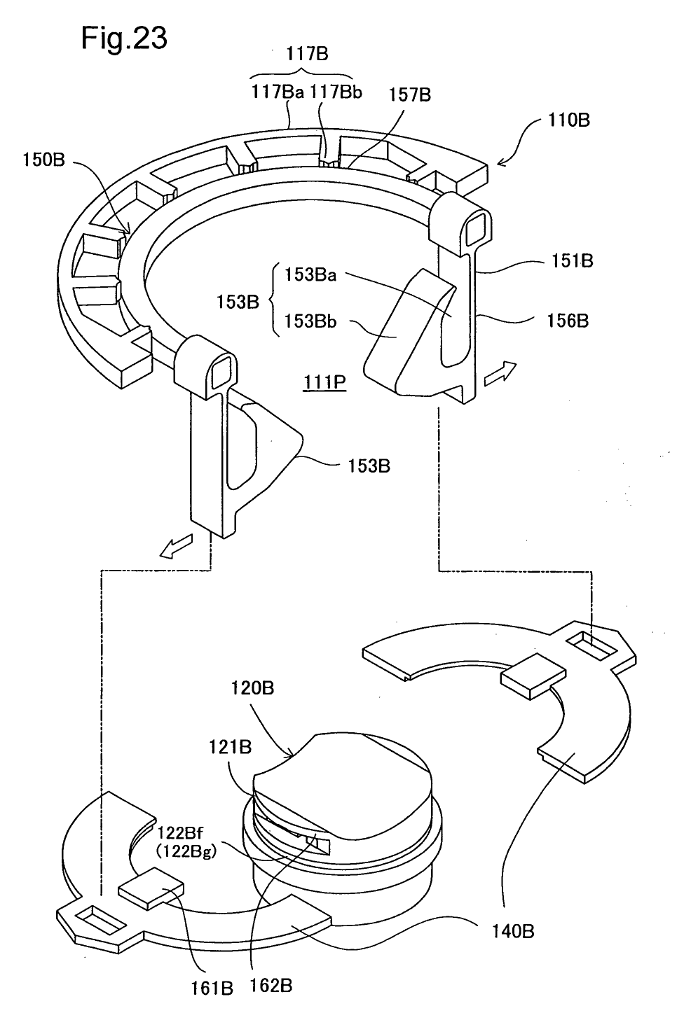

FIG. 23 is an exploded perspective view of a fuel tank opening-closing device 110B according to a fifth embodiment. A feature of the present embodiment is the arrangement of a nozzle detection mechanism 150B for detecting insertion of a fueling nozzle. Specifically, a nozzle detection member 151B of the nozzle detection mechanism 150B includes introductory push parts 153B situated to either side of the fuel passage 111P; resilient support pieces 156B linked at one end to the introductory push parts 153B and extending upwards; and a fastened linking arm 157B that links the resilient support pieces 156B at their upper portion. The fastened linking arm 157B is a band-shaped member of semicircular form fastened to the opening-defining member. A conductive member 117B has been positioned to the outside peripheral side of the fastened linking arm 157B. The conductive member 117B includes an annular base part 117a, and discharge protrusions 117Bb protruding out from the annular base part 117Ba and arranged so as to contact the fastened linking arm 157B. Notches 122B defining frangible regions 122Bg have been formed in the side portions of the opening-closing member 121B of the flap valve mechanism 120B. With this design, when the introductory push parts 153B, 153B are pushed towards the perpendicular direction with respect to the insertion direction by the fueling nozzle, spring force centered at the upper portion of the resilient support pieces 156B will be generated, causing the cover 140B to move in the retracting direction and to return to its initial position when the fueling nozzle is subsequently withdrawn. Because the fastened linking arm 157B does not undergo elastic deformation through deflection of the resilient support pieces 156B, a constant distance can be maintained from the discharge protrusions 117Bb of the conductive member 117B, and grounding action can take place more dependably. Furthermore, because the frangible regions 122Bg are formed by notches 122Bf made in the side portions of the opening-closing member 121B, the locked parts 162B will break when subjected to strong outside force received from the locking members 161B, so sealing function will be maintained. Besides an integrated spring as described above, various other modes, such as a separate coil spring or plate spring, could be employed as the arrangement whereby the nozzle detection mechanism generates spring force through traveling force of the introductory push parts.

### F. Sixth Embodiment

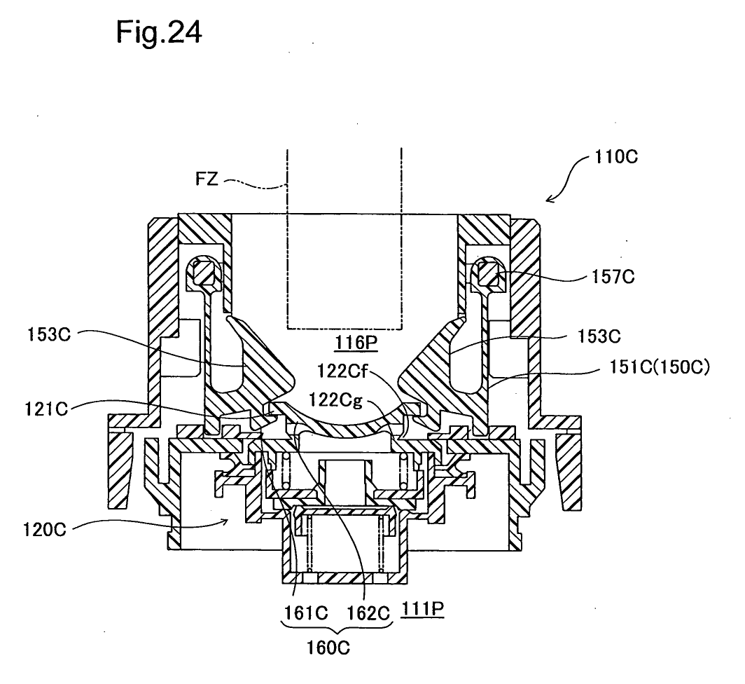

FIG. 24 is a sectional view of a fuel tank opening-closing device 110C according to a sixth embodiment. A feature of the present embodiment is the arrangement of a locking mechanism 160 that operates in interlocking fashion with insertion of the fueling nozzle FZ. Specifically, locking members 161C of the locking mechanism 160 have been integrally formed with introductory push parts 153C, and shuttle between a locked position at which the locking members 161C are engaged by locked parts 162C of an opening-closing member 121C, and an unlocked position at which through pushing of the introductory push parts 153C the locking members 161C have disengaged from the locked parts 162C so that the opening operation of the opening-closing member 121C becomes possible. Thus, an arrangement whereby the locking members 161C of the locking mechanism 160 shuttle between the locked position and the unlocked position with respect to the opening-closing member 121C through interlocking operation with the introductory push parts 153C is also acceptable. Furthermore, notches 122Cf have been made in the side portions of the opening-closing member 122 to form localized thin frangible regions 122Cg in the opening-closing member 122. When subjected to strong outside force from the locking members 161C, these frangible regions 122Cg will break so that sealing function is maintained. Further, discharge projections (not shown) like those in FIG. 23 can be arranged on a fastened linking arm 157C to provide a grounding path.

### G. Seventh Embodiment

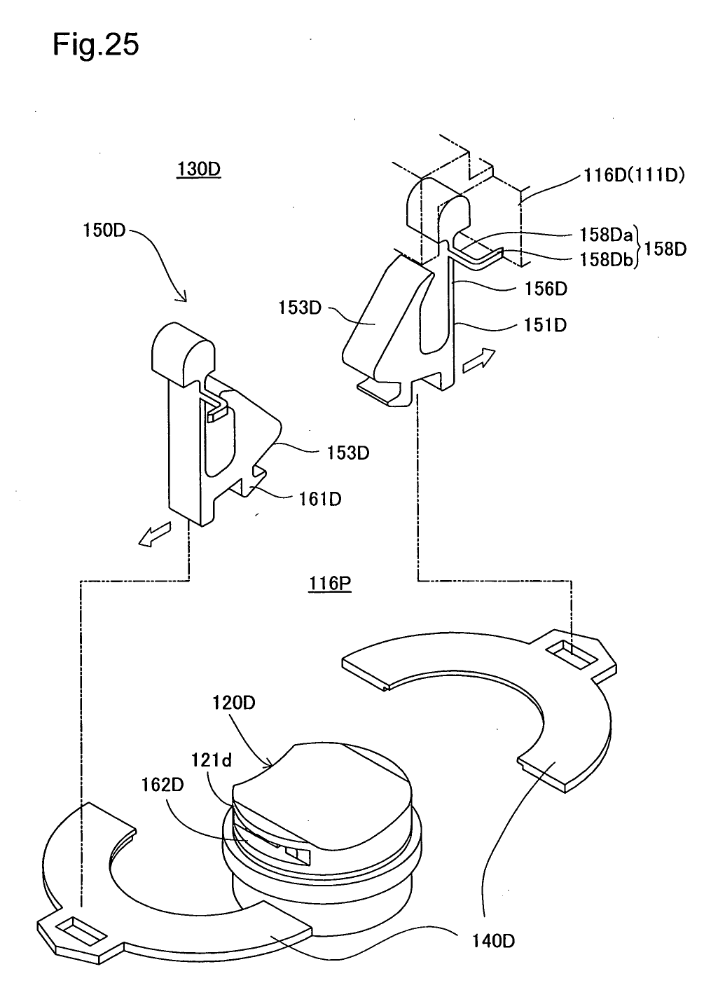

FIG. 25 is an illustration depicting a nozzle detection mechanism 150D of a fuel tank opening-closing device according a seventh embodiment. A feature of the present embodiment is the arrangement of a grounding path and nozzle detection members 151D of a nozzle detection mechanism 150D making up an opening-closing activation mechanism 130D. Specifically, the nozzle detection members 151D have a discharge protrusion integrally formed with the nozzle detection member of FIG. 23, that is, they include an introductory push part 153D situated to either side of the insertion passage 116P, and a resilient support piece 156D linked at one end to the introductory push part 153D and extending upwards. The resilient support piece 156D is fastened in its upper portion to an opening-defining member 116D of a tank opening forming member 111D. A conductive member 158D is formed in the side portion of the resilient support piece 156D. The conductive member 158D includes a cantilever piece 158Da projected out parallel to the inside wall of the opening-defining member 116D, and a discharge protrusion 158Dd the protrudes out towards the opening-defining member 116D side from the cantilever piece 158Da. With this arrangement, when the introductory push parts 153D are pushed towards the perpendicular direction with respect to the insertion direction by the fueling nozzle, spring force centered at the upper portion of the resilient support is pieces 156D will be generated, causing locking members 161D to disengage from locked parts 162D of an opening-closing member 121F of a flap valve mechanism 120D and thereby shuttle to the unlocked position, while causing a cover 140D to move in the retracting direction and to return to its initial position when the fueling nozzle is subsequently withdrawn. When the resilient support pieces 156D undergo elastic deformation, the discharge protrusion 158Db of the conductive member 158D, with the resilient support piece 156D as the fulcrum point, likewise will move closer to the opening-defining member 116D, thus providing more dependable contact with the opening-defining member 116D, as well as compensating for dimensional variations caused by deformation during molding or the like, so as to provide more dependable grounding action.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A fuel tank opening-closing device adapted to open and close a passage for supply of fuel to a fuel tank, comprising:
a tank opening forming member that forms a fuel passage connecting to the fuel tank from an insertion passage adapted for insertion of a fueling nozzle;
a flap valve mechanism situated inside the tank opening forming member and having an opening-closing member adapted to open and close a filler port; and
an opening-closing activation mechanism settable to a locked position in which opening operation of the opening-closing member is locked, and to an unlocked position in which opening operation of the opening-closing member is permitted when the opening-closing member is pushed by the fueling nozzle;
wherein the opening-closing activation mechanism includes:
a cover having cover bodies that are divided into arcuate shapes and are disposed covering a peripheral edge portion of the opening-closing member;
a nozzle detection mechanism having an introductory push part disposed in the insertion passage and adapted to receive force of motion in an insertion direction of the fueling nozzle; and mating parts adapted to move the cover bodies in a direction away from the opening-closing member through force of motion of the introductory push part; and
a locking mechanism having a locking member selectively shuttled to the locked position and the unlocked position, the locking member being configured to move from the locked position to the unlocked position through interlocking operation with the introductory push part.

2. The fuel tank opening-closing device in accordance with claim 1, wherein
the introductory push part has a plurality of members disposed along the peripheral edge of the fuel passage; and
the nozzle detection mechanism includes shaft bodies adapted to rotatably support the members of the introductory push part on the tank opening forming member respectively; and a linking arm linking the members of the introductory push part and adapted to produce spring force towards a direction of return to an original position through movement of the introductory push part.

3. The fuel tank opening-closing device in accordance with claim 2, wherein
the locking member is integrally formed on the cover body.

4. The fuel tank opening-closing device in accordance with claim 3, wherein
the flap valve mechanism has a gasket adapted to seal the opening-closing member and a rim of the filler port; and
the opening-closing member has a locked portion adapted to engage the locking member; and a frangible region with a notch close to a location sealed by the locked portion and the gasket.

5. The fuel tank opening-closing device in accordance with claim 1, wherein
the nozzle detection mechanism includes a cantilevered resilient support piece projecting from the tank opening forming member and adapted to produce spring force towards a direction of return to an original position through movement of the introductory push part.

6. The fuel tank opening-closing device in accordance with claim 5, wherein
the introductory push part has a plurality of members disposed along the peripheral edge of the fuel passage; and
the nozzle detection mechanism includes a fastened linking arm fastened to the tank opening forming member and linking the members of the introductory push part.

7. The fuel tank opening-closing device in accordance with claim 6, wherein
the locking member is integrally formed on the cover body.

8. The fuel tank opening-closing device in accordance with claim 7, wherein
the flap valve mechanism has a gasket adapted to seal the opening-closing member and a rim of the filler port; and
the opening-closing member has a locked portion adapted to engage the locking member; and a frangible region with a notch close to a location sealed by the locked portion and the gasket.

9. The fuel tank opening-closing device in accordance with claim 6, wherein
the locking members of the locking mechanism is integrally formed on the introductory push part.

10. The fuel tank opening-closing device in accordance with claim 9, wherein
the flap valve mechanism has a gasket adapted to seal the opening-closing member and a rim of the filler port; and
the opening-closing member has a locked portion adapted to engage the locking member; and a frangible region with a notch close to a location sealed by the locked portion and the gasket.

11. The fuel tank opening-closing device in accordance with claim 10, wherein
the tank opening forming member and the introductory push part are fabricated of conductive material, and constitute a grounding path to a body member of a vehicle;
the tank opening forming member has a conductive member fabricated of electrically conductive material and disposed facing the fastened linking arm; and
the conductive member has discharge protrusions disposed facing the fastened linking arm and protruding out towards the fastened linking arm.

12. The fuel tank opening-closing device in accordance with claim 10, wherein
the nozzle detection mechanism has a resilient support piece fastening the introductory push part at an end thereof in cantilever fashion to the tank opening forming member and adapted to produce spring force towards the direction of return to the original position through movement of the introductory push part;
the tank opening forming member and the introductory push part are fabricated of conductive material, and constitute a grounding path to a body to member of a vehicle; and
the resilient support piece has a conductive member fabricated of electrically conductive material and disposed facing the tank opening forming member, wherein the conductive member has a discharge protrusion projected out towards the tank opening forming member.

13. The fuel tank opening-closing device in accordance with claim 1, wherein
the flap valve mechanism has a gasket adapted to seal the opening-closing member and a rim of the filler port; and
the opening-closing member has a locked portion adapted to engage the locking member; and a frangible region with a notch close to a location sealed by the locked portion and the gasket.

14. The fuel tank opening-closing device in accordance with claim 13, wherein
the locked part is a recess adapted to engage the locking member and formed on a portion of the opening-closing member; and the notch is formed at a bottom of the recess and reduce a thickness of the opening-closing member about an entire circumference of the opening-closing member.

15. The fuel tank opening-closing device in accordance with claim 1, wherein
the locking member is integrally formed on the cover body.

16. The fuel tank opening-closing device in accordance with claim 1, wherein
the locking member of the locking mechanism is integrally formed on the introductory push part.

17. The fuel tank opening-closing device in accordance with claim 1, wherein
the tank opening forming member and the introductory push part are fabricated of conductive material, and constitute a grounding path to a body member of a vehicle.

18. The fuel tank opening-closing device in accordance with claim 17, wherein
the nozzle detection mechanism has a resilient support piece fastening the introductory push part at an end thereof in cantilever fashion to the tank opening forming member and adapted to produce spring force towards a direction of return to an original position through movement of the introductory push part; and
the resilient support piece has a conductive member fabricated of electrically conductive material and disposed facing the tank opening forming member, wherein the conductive member has a discharge protrusion projected out towards the tank opening forming member.

19. The fuel tank opening-closing device in accordance with claim 17, wherein
the introductory push part has a plurality of members disposed along the peripheral edge of the fuel passage;
the nozzle detection mechanism includes shaft bodies adapted to rotatably support the members of the introductory push part on the tank opening forming member respectively, and a linking arm linking the members of the introductory push part and adapted to produce spring force towards a direction of return to an original position through movement of the introductory push part; and
the tank opening forming member has a conductive member fabricated of electrically conductive material and disposed facing the linking arm, wherein the conductive member has discharge protrusions disposed facing the linking arm and projected out towards the linking arm.

20. The fuel tank opening-closing device in accordance with claim 17, wherein
the introductory push part has a plurality of members that are disposed surrounding the insertion passage, fastened at an end thereof in cantilever fashion to the tank opening forming member, and formed so as to produce spring force towards a direction of return to an original position through movement of the introductory push part;
the nozzle detection mechanism includes a fastened linking arm fastened to the tank opening forming member and linking the members of introductory push part; and
the tank opening forming member has a conductive member fabricated of electrically conductive material and disposed facing the fastened linking arm, wherein the conductive member has discharge protrusions disposed facing the fastened linking arm and protruding out towards the fastened linking arm.
